(19) United States
(12) Patent Application Publication
(10) Pub. No.: US 2005/0252085 A1
(43) Pub. Date: Nov. 17, 2005

(54) Windows opening/closing driving device

(75) Inventor: Chin-Hsueh Chang, Taichung (TW)

Correspondence Address: BACON & THOMAS, PLLC, 625 SLATERS LANE, FOURTH FLOOR, ALEXANDRIA, VA, 22314, US

(73) Assignee: CARPENTER MACHINERY CO., LTD., Taichung (TW)

(21) Appl. No.: 10/842,458

(22) Filed: May 11, 2004

(51) Int. Cl. E05D 15/52

(52) U.S. Cl. 49/73.1

(57) ABSTRACT

A windows opening/closing driving device is mounted on a building and connected with a plurality of windows, including driving means fixed on the building, returning means fixed on the building, a rope passing by the windows and having two ends respectively connected with the driving means and the returning means, and a plurality of connecting members each having two connecting portions respectively connected with the rope and one of the windows.

### BACKGROUND OF THE INVENTION

1. Field of the Invention

The present invention relates generally to driving technology of opening/closing a window, and more particularly to a windows opening/closing driving device.

2. Description of the Related Art

Generally, a plurality of windows are mounted on the high walls of a factory, which is not air-conditioned, for well ventilation. However, if the windows are located high and are numerous, it will be very inconvenient to open/close the windows for the user. In addition, if the factory is on fire accidentally, the windows may not be opened immediately for ventilation, and therefore the improvement is required.

To improve the aforementioned problem, an electrically controlled driver for the windows is invented. The electrically controlled driver includes a set of a motor and a screw rod. The screw rod is driven to lengthen/shorten itself by the motor to electrically control one window to be opened/closed. However, the motor and the screw rod cost a lot, and if the user intends to open/close a large number of windows, it will be necessary to install a set of the motor and the screw rod on each of the windows, such that the production cost will be relatively increased to incur universal unpopularity of the electrically controlled driver for the public.

As shown in FIGS. 12 and 13, a conventional window opening/closing driving mechanism 100 is comprised of a motor 101, a plurality of gears 103, a screw rod 102 driven by the motor 101 to drive the gears 103 to rotate, and a connecting rod 104 connected with each of the gears 103 for driving the window to be opened/closed. When there are more windows, the screw rod 102 has to be lengthened so as to increase more production cost. In addition, the screw rod 102 is subject to axial curvature while it is lengthened overmuch to cause unstable status like shaking or trembling during the rotation to further incur noise or vibration or other problems.

### SUMMARY OF THE INVENTION

The primary objective of the present invention is to provide a windows opening/closing driving device, which is structurally simple for synchronically driving windows to be opened/closed and which production cost is lower than the prior art.

The secondary objective of the present invention is to provide a windows opening/closing driving device, which can control numerous windows to be opened/closed once by an easy way.

The third objective of the present invention is to provide a windows opening/closing driving device, which is almost noiseless and of no vibration.

The foregoing objectives of the present invention are attained by the windows opening/closing driving device, which is mounted on a building and connected with a plurality of windows and includes driving means fixed on the building, returning means fixed on the building, a rope passing by the windows and having two ends respectively connected with the driving means and the returning means, and a plurality of connecting members each having two connecting portions respectively connected with the rope and one of the windows.

### BRIEF DESCRIPTION OF THE DRAWINGS

FIG. 1 is a schematic view of a first preferred embodiment of the present invention;

FIG. 2 is a partial enlarged exploded view of the first preferred embodiment of the present invention;

FIG. 3 is a partial enlarged perspective view of the first preferred embodiment of the present invention;

FIG. 4 is a schematic view of the first preferred embodiment of the present invention mounted on a building and connected with numerous windows for operation;

FIG. 5 is a partial enlarged perspective view of the first preferred embodiment of the present invention mounted on a building and connected with the numerous windows for operation, showing that a connecting member is mounted on a crossbar of a window;

FIG. 6 is a schematic view of the first preferred embodiment of the present invention mounted on the building and connected with the numerous windows in operation;

FIG. 7 is a schematic view of a second preferred embodiment of the present invention;

FIG. 8 is a partial enlarged exploded view of a third preferred embodiment of the present invention;

FIG. 9 is a schematic view of a fourth preferred embodiment of the present invention;

FIG. 10 is a schematic view of a fifth preferred embodiment of the present invention;

FIG. 11 is a schematic view of a sixth preferred embodiment of the present invention;

FIG. 12 is a perspective view of the prior art mounted on three windows for operation; and

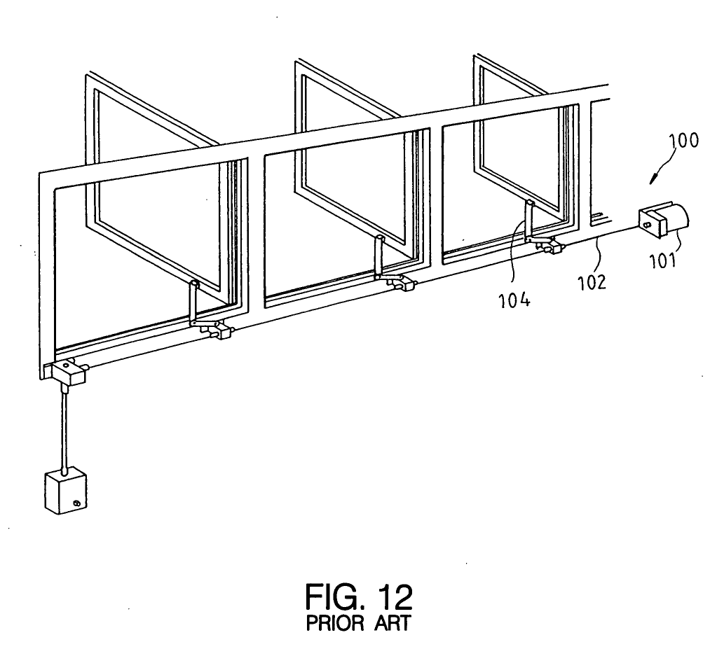

FIG. 13 is a top view of the prior art in operation.

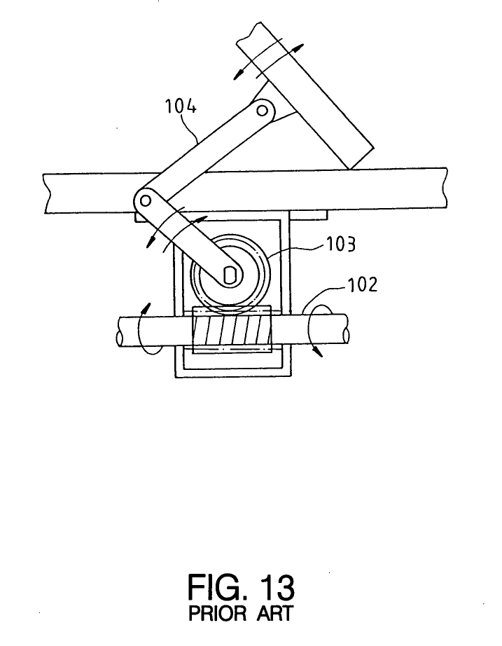

### DETAILED DESCRIPTION OF PREFERRED EMBODIMENTS

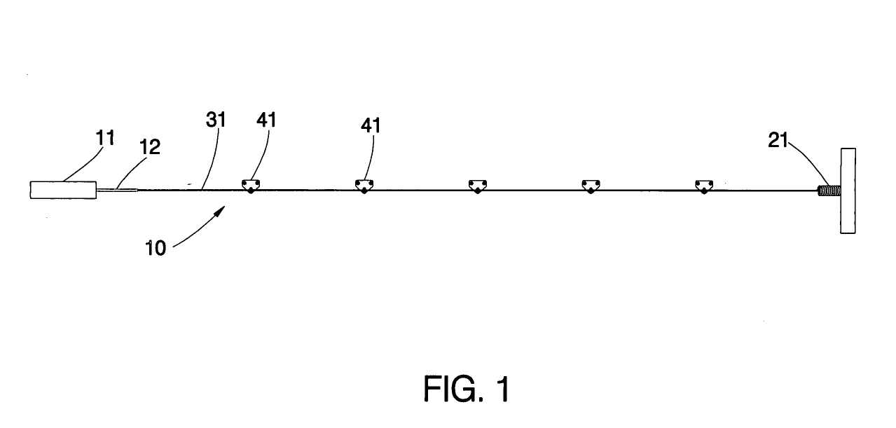

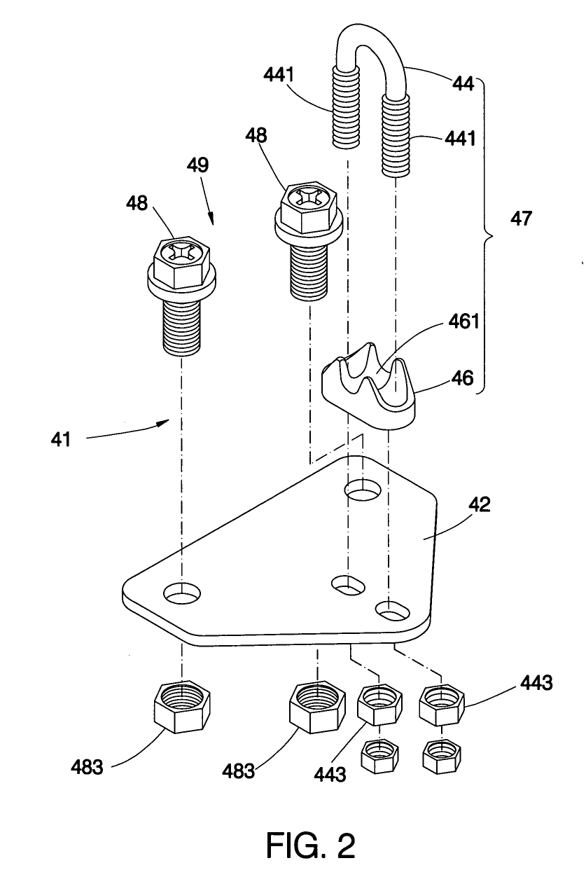

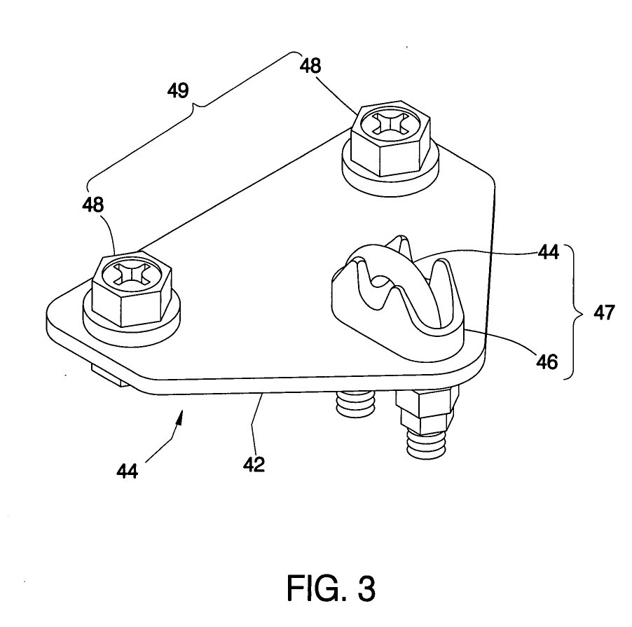

Referring to FIGS. 1-4, a windows opening/closing driving device 10 constructed according to a first preferred embodiment of the present invention is mounted on a building and connected to a plurality of windows 99 of the building, wherein the windows 99 are arranged in a row and can be transversally pulled to be opened/closed. The windows opening/closing driving device 10 is comprised of driving means 11, returning means 21, a rope 31, and a plurality of connecting members 41.

The driving means 11 for generating driving force is embodied as a pneumatic/hydraulic cylinder and is fixedly mounted on the building, including a piston rod 12.

The returning means 21 for generating inversive resilience is embodied as a spring and is fixedly mounted on the building.

The rope 31 that is embodied as a steel rope includes two ends connected respectively with the piston rod 12 and the returning means 21 and passes by the widows 99. A crossbar 991 is mounted on bilateral sides of a window frame of each of the windows 99.

Each of the connecting members 41 includes a plate 42, a U-shaped bar 44, and a holder 46. The plate 42 has a plurality of through holes for the U-shaped bar 44 and two bolts 48 running through. The U-shaped bar 44 has a curved portion and two lateral portions 441 extending respectively from two ends of the curved portion. The holder 46 has a recess 461 facing the curved portion of the U-shaped bar for the rope 31 passing through, and two through holes (not shown) for the two lateral portions 441 passing through. The two lateral portions 441 of the U-shaped bar 44 are inserted through the two through holes of the holder 46 and then through the two through holes of the plate 42 and threadedly connected with by screws 443, such that the holder 46 is mounted between the U-shaped bar 44 and the plate 42, further defining a first connecting portion 47. The rope is inserted through the recess 461 of the holder 46 to be fixedly clamped by the U-shaped bar 44 and the holder 46. The two bolts 48 are inserted through the other two through holes of the plate 42 and are fixedly connected with the plate 42 by two screws 483, further defining a second connecting portion 49, and meanwhile, the two bolts 48 are inserted through the crossbar 991 of the window 99 to enable the connecting member 41 to be fixedly connected with the crossbar 991.

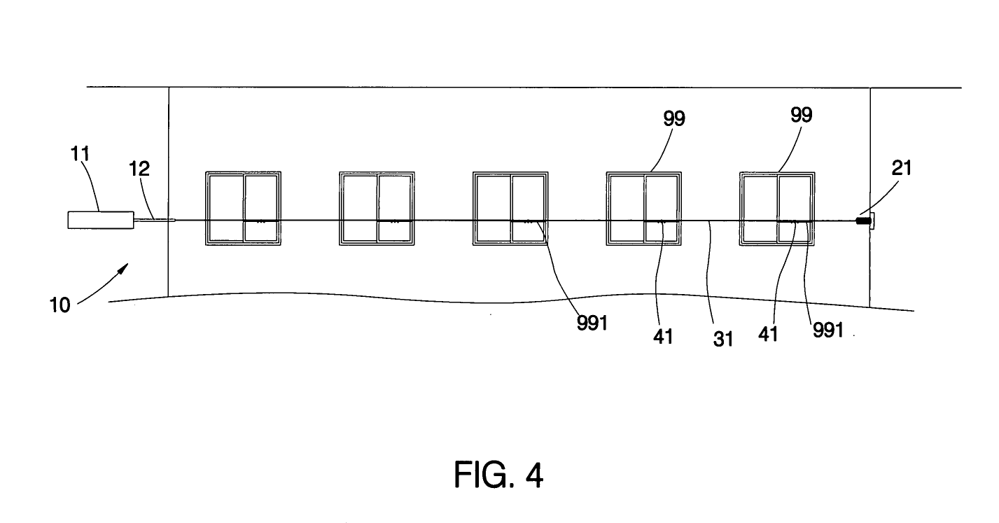

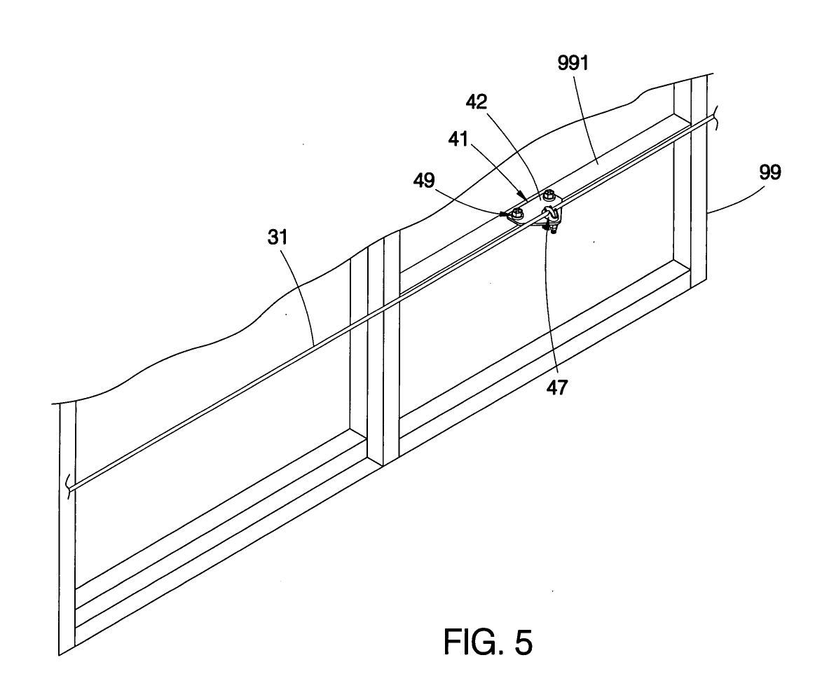

Referring to FIGS. 4 and 5, while installing the windows opening/closing driving device 10, install the driving means 11 at a side of the windows 99, then install the returning means 21 respectively at the other side of the windows 99, then enable the two ends of the rope 31 to be connected respectively with the piston rod 12 of the driving means 11 and the returning means 21, then install each of the crossbars 991 respectively on the bilateral sides of the window frame of each of the windows 99, and finally install the second connecting portions 49 respectively on the crossbars 991. The first connecting portion 47 of each of the connecting members 41 fixedly clamps the rope 31 by the U-shaped bar 44, the holder 46, and the screws 443. The second connecting portion 49 of each of the connecting members 41 are fixedly connected with the crossbars 991 by the screws 483.

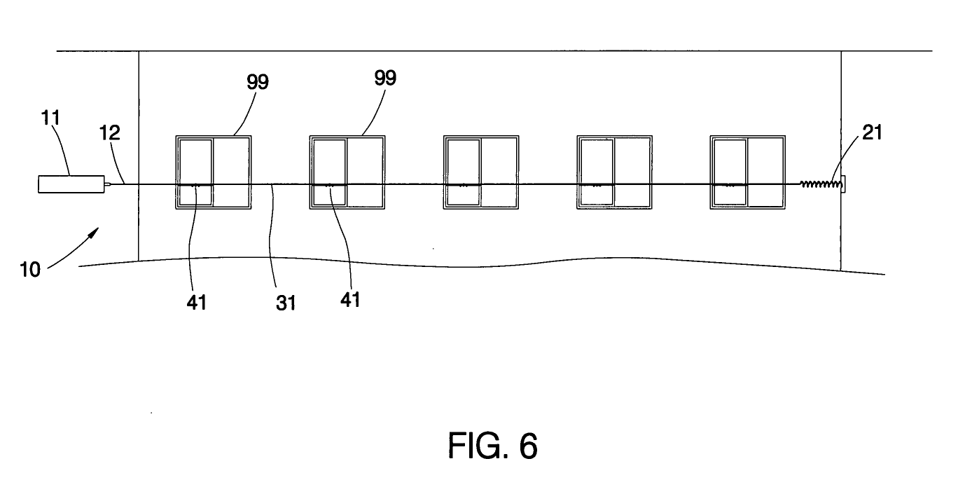

The windows opening/closing driving device 10 of the present invention is at an initial status of being controlled to open/close the windows 99, which are closed as shown in FIG. 4. While the windows opening/closing driving device 10 is controlled to open the windows 99, as shown in FIG. 6, the user can activate the driving means 11 to drive the piston rod 12 to move, then the rope 31 is driven by the piston rod 12 to synchronically to move and further open the windows 99, and meanwhile, the returning means 21 is pulled by the rope 31 to generate inversive resilience against the rope 31. When the user intends to close the windows 99, the user can re-activate the driving means 11 to drive the piston rod 12 to conversely move, and meanwhile, the inversive resilience of the returning means 21 pulls the rope 31 back to further close the windows 99, such that the windows 99 are closed as the initial status in FIG. 4.

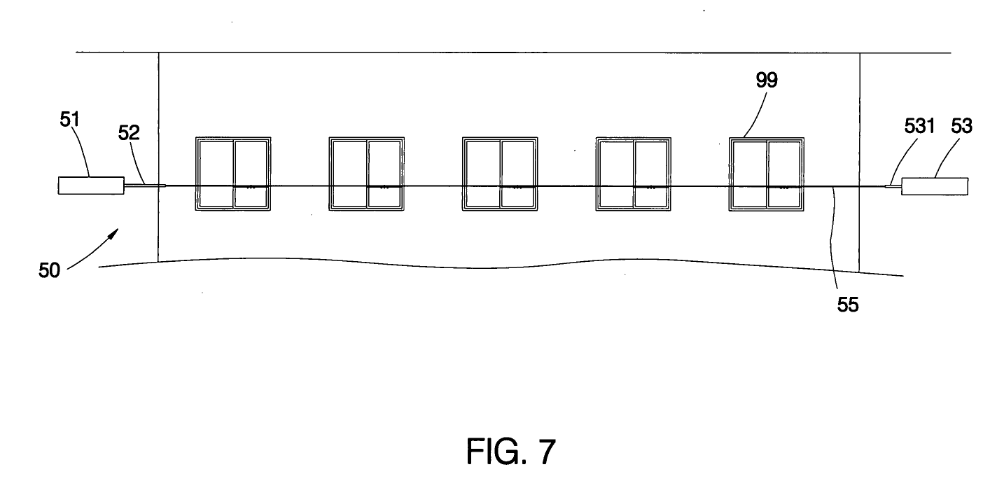

Referring to FIG. 7, the windows opening/closing driving device 50 constructed according to a second preferred embodiment of the present invention is mostly the same with the first preferred embodiment and the difference between them is recited hereafter. The returning means 53 is a pneumatic/hydraulic cylinder, which has a piston rod 531 connected to an end of the rope 55. When the windows opening/closing driving device 50 is operated to open the windows 99, the driving means 51 and the returning means 53 are activated to drive the screw rod 52 to be shortened and to drive the screw rod 531 to be lengthened, such that the rope 55 is moved synchronically to open the windows 99. When the windows opening/closing driving device 50 is operated to close the windows 99, the driving means 51 and the returning means 53 are activated to drive the screw rod 52 to be lengthened and to drive the screw rod 531 to be shortened, such that the rope 55 is moved synchronically to close the windows 99.

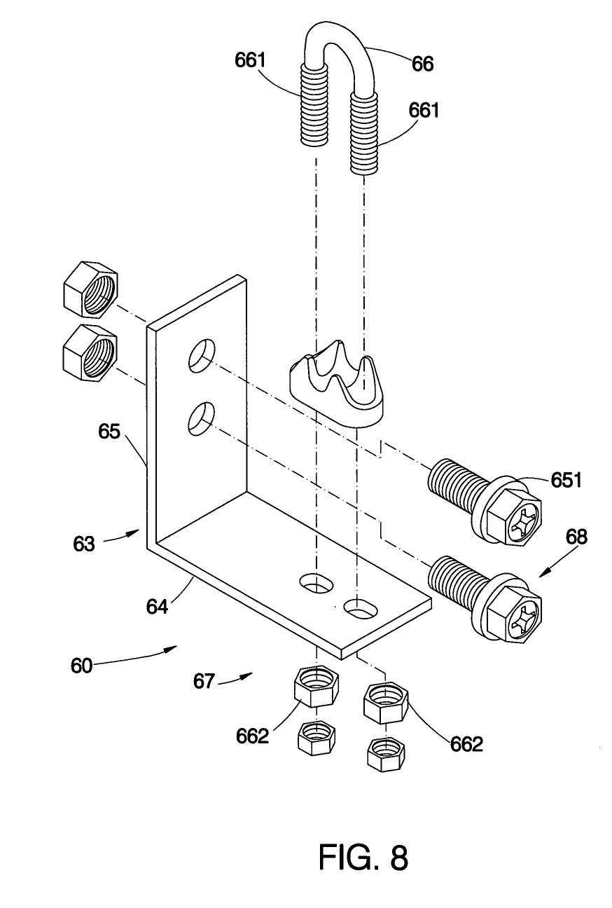

Referring to FIG. 8, the windows opening/closing driving device 60 constructed according to a third preferred embodiment of the present invention is mostly the same with the first preferred embodiment and the difference between them is recited hereafter. Each of the connecting members 63 is a L-shaped plate, including a first plate member 64, a second plate member 65, the U-shaped bar 66, the holder, two through holes formed on each of the first and second plate members 64 and 65, two bolts 651, and screws 662. The first and second plate members 64 and 65 are substantially perpendicular to each other. The two lateral portions 661 of the U-shaped bar 66 are inserted through the holder and the through holes of the first plate member 64, and then the screws 662 are threadedly mounted to the two lateral portions 661, such that the U-shaped bar 66, the holder, and the first plate member 64 are fixedly interconnected, further defining a first connecting portion 67. The two bolts 651 are inserted through the two through holes of the second plate member 65 and the crossbar 991 of the window 99 and then threadedly mounted with screws such that the second plate member 65 are fixedly mounted on the crossbar 991, further defining a second connecting portion 68. The windows opening/closing driving device 60 is also operated by the same way as the windows opening/closing driving device 10 of the first preferred embodiment.

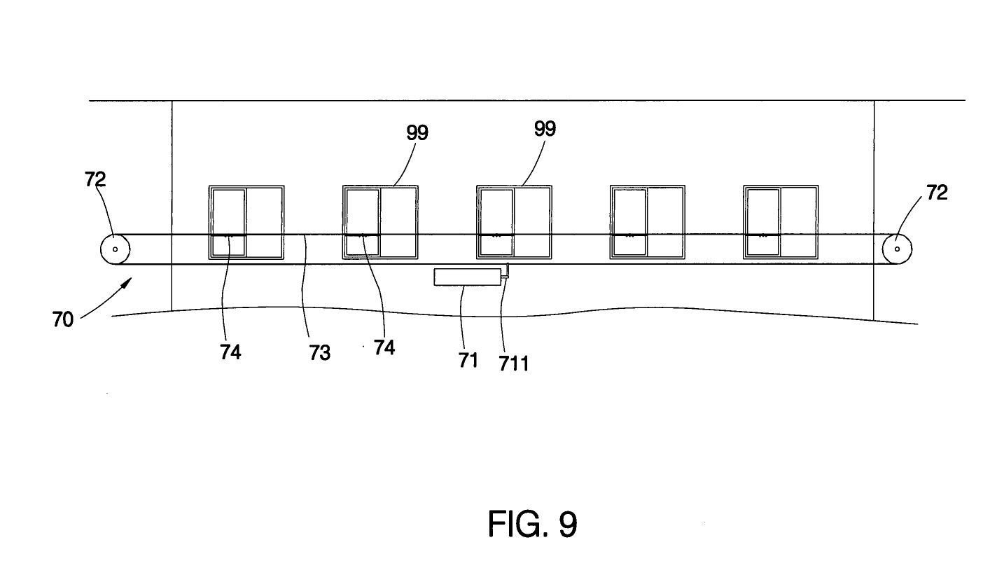

Referring to FIG. 9, the windows opening/closing driving device 70 constructed according to a fourth preferred embodiment of the present invention is mostly the same with the first preferred embodiment and the difference between them is recited hereafter. Without the returning means, the windows opening/closing driving device 70 further includes at least one pulley 72. The driving means 71 is embodied as a pneumatic/hydraulic cylinder having a piston rod 711 and is mounted on the building. The at least one pulley 72 is embodied as two pulleys 72 mounted on the building and positioned at two sides of the windows 99. The rope 73 is an endless rope connected with the piston rod 711 of the driving means 71 and running around the two pulleys 72. Each of the connecting members 74 is structurally the same as the connecting member 41 in the first preferred embodiment and is connected with the window 99 and the rope 73 by the same way as the first preferred embodiment. When the windows opening/closing driving device 70 is operated to open/close the windows 99, the piston rod 711 of the driving means 71 is driven to drive the rope 73 to run around the two pulleys 72 to further open/close the windows 99.

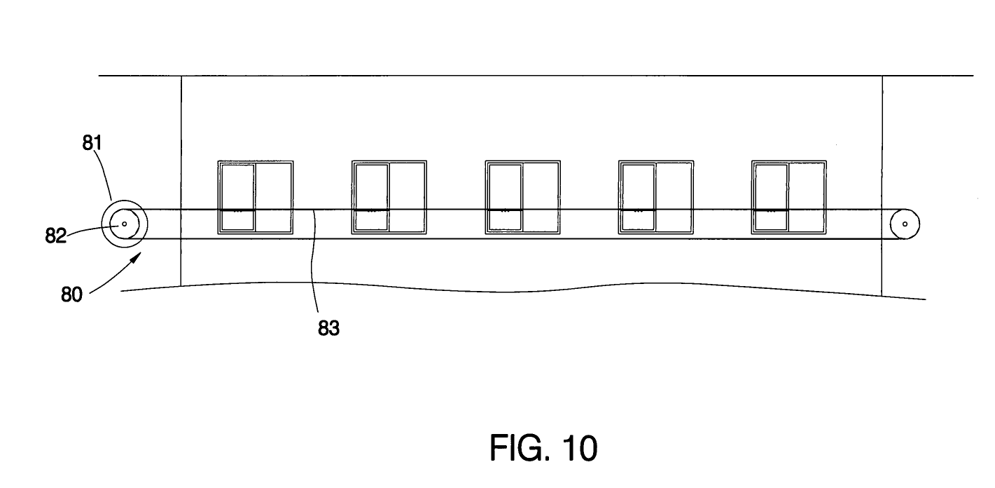

Referring to FIG. 10, the windows opening/closing driving device 80 constructed according to a fifth preferred embodiment of the present invention is mostly the same with the fourth preferred embodiment and the difference between them is recited hereafter. The driving means 81 is a motor connected with one of the two pulleys 82 for driving the pulleys 82 and further the rope 83 to move.

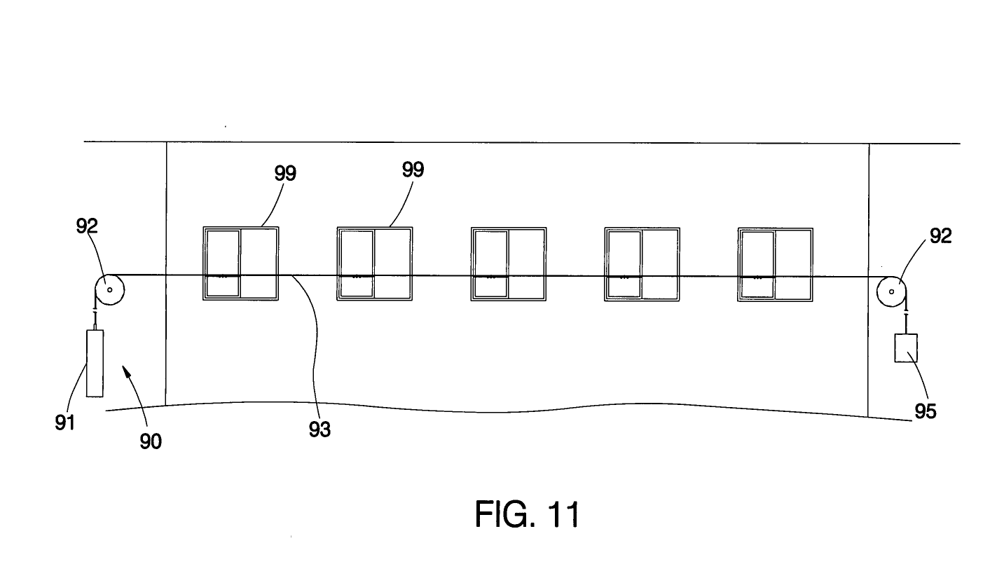

Referring to FIG. 11, the windows opening/closing driving device 90 constructed according to a sixth preferred embodiment of the present invention is mostly the same with the fourth preferred embodiment and the difference between them is recited hereafter. The driving means 91 is a pneumatic/hydraulic cylinder mounted on the building. The two pulleys 92 are respectively positioned at the two sides of the windows 99. The rope 93 is provided with two ends respectively connected with the driving means 91 and a weighty mass 95 and runs on the two pulleys 92, wherein the weighty mass 95 generates the inversive resilience by gravity. The windows opening/closing driving device 90 is operated by the same way as the windows opening/closing driving device 10 of the first preferred embodiment.

From the above recitation, the present invention includes advantages as follows.

1. The present invention can be operated to synchronically open/close the numerous windows by the coordination of merely a pneumatic/hydraulic cylinder or a motor, a steel rope, and a plurality of connecting members, the components are commercially inexpensive and available, and one window merely corresponds to one connecting member, thereby being structurally simple and low in production cost.

2. The present invention can control the numerous windows to be opened/closed once at the same time to be very convenient for the user's operation.

3. In the present invention, the rope is pulled by the driving means (pneumatic/hydraulic cylinder or screw rod), and none of additional noise like that in the prior art will be generated except the sound generated while the driving means is working.

4. When the pneumatic cylinder is used as the driving means and the windows are transversally moved, even if the path that the rope passes by is hindered by a stone or others, the pneumatic cylinder will not be subject to mechanical damage because the air inside the pneumatic cylinder is of flexibility.

1. A windows opening/closing driving device mounted on a building and connected with a plurality of windows of the building, said windows opening/closing driving device comprising:
driving means for generating driving force, said driving means being fixed on said building;
returning means for generating resilience, said returning means being fixed on said building;
a rope having two ends respectively connected with said driving means and said returning means and passing by said windows; and
a plurality of connecting members each having two connecting portions respectively connected with said returning means and said windows.

2. The windows opening/closing driving device as defined in claim 1, wherein said returning means is a spring.

3. The windows opening/closing driving device as defined in claim 1, wherein said rope is steel rope.

4. The windows opening/closing driving device as defined in claim 1, wherein said driving means is a pneumatic/hydraulic cylinder having a piston rod.

5. The windows opening/closing driving device as defined in claim 1, wherein said windows each comprising a crossbar mounted on bilateral sides of a window frame thereof; each of said second connecting portions of said connecting members is connected with said crossbar.

6. The windows opening/closing driving device as defined in claim 5, wherein each of said connecting members comprises a plate, a U-shaped bar, and two bolts, said U-shaped having a curved portion and two lateral portions extending respectively from said curved portion, said two lateral portions being inserted through said plate and then threadedly connected with screws, whereby a first connecting portion is formed, said two bolts being inserted through said plate and threadedly connected with screws, whereby a second connecting portion is formed.

7. The windows opening/closing driving device as defined in claim 6, wherein each of said connecting members further comprises a holder mounted between said plate and said two lateral portions of said U-shaped bar, said holder having a recess facing said curved portion of said U-shaped bar.

8. The windows opening/closing driving device as defined in claim 1, wherein each of said connecting members is a L-shaped plate, a U-shaped bar, and two bolts, said L-shaped plate having a first plate member and a second plate member substantially perpendicular to each other, said U-shaped bar having a curved portion and two lateral portions extending respectively from said curved portion, said two lateral portions being inserted through said first plate member and then threadedly connected with screws, whereby a first connecting portion is formed, said two bolts being inserted through said second plate member and threadedly connected with screws, whereby a second connecting portion is formed.

9. The windows opening/closing driving device as defined in claim 1, wherein said returning means is driving means.

10. A windows opening/closing driving device mounted on a building and connected with a plurality of windows of the building, said windows opening/closing driving device comprising:
driving means fixed on said building;
at least one pulley mounted on a predetermined position of said building;
a rope connected with said driving means and running on said pulley, said rope passing by said windows; and
a plurality of connecting members each having two connecting portions respectively connected with said rope and said windows.

11. The windows opening/closing driving device as defined in claim 10, wherein said at least one pulley is two in number, said two pulleys being respectively positioned at bilateral sides of said windows; said rope is endless and runs around said two pulleys.

12. The windows opening/closing driving device as defined in claim 11, wherein said driving means is a pneumatic/hydraulic cylinder having a piston rod connected with said rope.

13. The windows opening/closing driving device as defined in claim 11, wherein said driving means is a motor connected with one of said two pulleys for driving said one pulley to further move said rope.

14. The windows opening/closing driving device as defined in claim 10, wherein said driving means is a pneumatic/hydraulic cylinder; said at least one pulley is two in number, said two pulleys being respectively positioned at bilateral sides of said windows; said rope having two ends respectively connected with said driving means and a weight mass and running on said two pulleys, said weighty mass generating resilience by gravity.
